(19) United States
(12) Patent Application Publication
(10) Pub. No.: US 2025/0349472 A1
(43) Pub. Date: Nov. 13, 2025

(54) ELECTRET

(71) Applicants: DENSO CORPORATION, Kariya-city (JP); TOKYO UNIVERSITY OF SCIENCE FOUNDATION, Tokyo (JP)

(72) Inventors: Noriyuki MATSUSHITA, Kariya-city (JP); Takuya IGASHIRA, Kariya-city (JP); Kazuhiko KANO, Kariya-city (JP); Yumi TANAKA, Tokyo (JP)

(21) Appl. No.: 19/071,521

(22) Filed: Mar. 5, 2025

(30) Foreign Application Priority Data
May 8, 2024 (JP) 2024-075797

(51) Int. Cl. H01G 7/02; H02N 1/08

(52) U.S. Cl. CPC H01G 7/026; H02N 1/08

(57) ABSTRACT

An electret includes a substrate, and an electret layer formed on a surface of the substrate. The electret layer is an inorganic dielectric layer that has been electrically charged. The inorganic dielectric layer includes an outer layer and an inner layer that are stacked in a thickness direction of the substrate. The outer layer contains a first inorganic dielectric material as a main component which is a composite metal compound including different metal elements and has a bandgap energy of 3 eV or more. At least one of the different metal elements being a trivalent metal element. The inner layer contains a second inorganic dielectric material as a main component which is different from the first inorganic dielectric material.

### CROSS REFERENCE TO RELATED APPLICATION

The present application claims the benefit of priority from Japanese Patent Application No. 2024-075797 filed on May 8, 2024. The entire disclosure of the above application is incorporated herein by reference.

### TECHNICAL FIELD

The present disclosure relates to an electret.

### BACKGROUND

Electrets are electrically charged materials that provide an electrostatic field to their surroundings.

### SUMMARY

According to an exemplar of the present disclosure, an electret including a substrate and an electret layer formed on a surface of the substrate is provided. The electret layer is an inorganic dielectric layer that has been electrically charged. The inorganic dielectric layer includes an outer layer and an inner layer that are stacked in a thickness direction of the substrate. The outer layer contains a first inorganic dielectric material as a main component. The first inorganic dielectric material is a composite metal compound including different metal elements and has a bandgap energy of 3 eV or more. At least one of the different metal elements is a trivalent metal element. The inner layer contains a second inorganic dielectric material as a main component. The second inorganic dielectric material is different from the first inorganic dielectric material.

### BRIEF DESCRIPTION OF THE DRAWINGS

FIG. 1 is a schematic view showing the configuration of an electret according to a first embodiment.

FIG. 2 is a schematic view showing a configuration example of the electret according to the first embodiment.

FIG. 3 is a schematic view showing a configuration example of an electret according to a second embodiment.

FIG. 4 is a schematic view showing the configuration of an electret of a comparative example and a diagram showing the relationship between a heating treatment and a surface potential.

FIG. 5 is a diagram showing the relationship between the thickness of the inner layer of the electret and the surface potential in working examples.

FIG. 6 is a diagram showing the relationship between the elapsed time after a charging treatment and the surface potential in the working examples.

FIG. 7 is a diagram showing the relationship between the thickness of the outer layer of the electret and the surface potential in working examples.

FIG. 8 is a diagram showing the relationship between the elapsed time after the charging treatment and the surface potential in the working example.

FIG. 9 is a diagram showing the relationship between the thickness of the inner layer of the electret and the surface potential in working examples.

FIG. 10 is a diagram showing the relationship between the elapsed time after the charging treatment and the surface potential in the working examples.

FIG. 11 is a diagram showing the relationship between the thickness of the inner layer of the electret and the surface potential in working examples.

FIG. 12 is a diagram showing the relationship between the thickness of the inner layer of the electret and the surface potential in working examples.

FIG. 13 is a diagram showing the relationship between the elapsed time after the charging treatment and the surface potential in the working examples.

FIG. 14 is a diagram showing the relationship between the elapsed time after the charging treatment and the surface potential in working examples.

FIG. 15 is a schematic view showing the configuration of an electret in a comparative example.

FIG. 16 is a diagram showing the relationship between the elapsed time after the charging treatment and the surface potential in comparative examples.

FIG. 17 is a diagram showing the relationship between the elapsed time after the charging treatment and the surface potential in the comparative example.

FIG. 18 is a diagram showing the relationship between the elapsed time after the charging treatment and the surface potential in the working example and the comparative example.

FIG. 19 is a diagram showing the relationship between the elapsed time after the charging treatment and the surface potential in the working example and the comparative example.

### DESCRIPTION OF EMBODIMENTS

To begin with, examples of relevant techniques will be described.

Electrets are electrically charged materials that provide an electrostatic field to their surroundings. They have been used in applications such as electret condenser microphones and dust-collecting filters. Moreover, in recent years, electrets have been attracting attention for applications to vibration power generation, which is one of the energy harvesting technologies. For example, the practical application of a small vibration energy harvesting device with electrets, as an integrated circuit embedded device used in electrostatic vibration energy harvesters driven by environmental vibrations, is highly anticipated.

The electret is generally formed of an organic polymer material such as a fluorine-based resin. Organic polymer materials offer advantages in shape flexibility and thickness controllability in thin layer formation. However, organic polymer materials raise concerns about the thermal stability of the surface potential and temporal performance degradation. Thus, inorganic compound materials, which are superior in the thermal stability to organic polymer materials, are being examined for application in electrets. Electrets formed of, as inorganic compound materials, bulk sintered hydroxyapatite or composite oxides with a perovskite structure are known.

Furthermore, power generation elements using inorganic electrets can be integrated into circuits formed on substrates, enabling miniaturization of power generation devices and their use in high-temperature environments. This opens up possibilities for various applications. Then, the inventors of this application has proposed an electret including a substrate and an electret layer, which is a thin layer mainly formed of an inorganic dielectric material, on the substrate. The inorganic dielectric material is a composite metal compound including different metal elements and having a bandgap energy of 4 eV or more.

The inorganic dielectric material for the proposed electret contains two or more metal elements and has a high bandgap energy, which helps control defects and allows for polarization treatment at high voltage and high temperatures. As a result, the electret is considered to exhibit a high surface potential. The electret has a relatively stable surface potential in a temperature environment above room temperature (for example, around 100° C.). However, the electret faces challenges in maintaining the high surface potential developed immediately after conversion to an electret. In particular, it has been found that the surface potential is easily lost over time in high temperature environments exceeding 100° C. (e.g., 200° C. or higher). Thus, improvements in long-term stability are needed.

There is an electret including an electret thin film made of a conventional inorganic compound material, a fluorine-based organic polymer material, or a combination of these materials on a substrate. However, the inorganic compound materials typically used in element formation do not provide high surface potentials. While fluorine-based organic polymer materials exhibit a relatively high surface potential at room temperature, they have low heat resistance and are difficult to apply to elements used in high-temperature environments.

The present disclosure has been made in view of such issues, and aims to provide an electret that can maintain a high surface potential for a long period even in a high-temperature environment and has excellent thermal and temporal stability.

According to an exemplar of the present disclosure, an electret including a substrate and an electret layer formed on a surface of the substrate is provided. The electret layer is an inorganic dielectric layer that has been electrically charged. The inorganic dielectric layer includes an outer layer and an inner layer that are stacked in a thickness direction of the substrate. The outer layer contains a first inorganic dielectric material as a main component. The first inorganic dielectric material is a composite metal compound including different metal elements and has a bandgap energy of 3 eV or more. At least one of the different metal elements is a trivalent metal element. The inner layer contains a second inorganic dielectric material as a main component. The second inorganic dielectric material is different from the first inorganic dielectric material.

In a configuration in which an electret layer is formed on a substrate, charges tend to migrate from the surface of the electret layer in contact with the substrate in a high-temperature environment, which leads to a decrease in the surface potential. In contrast, the electret of this embodiment has an electret layer having a stacked structure including an outer layer and an inner layer. This enables stable high surface potential even in high temperatures. The reason for this is not entirely clear, but it is presumed that the outer layer containing, as a main component, a first inorganic dielectric material that is a specific composite metal oxide with a bandgap energy of 3 eV or more exhibits a high surface potential through a charging treatment and the inner layer containing, as a main component, a second inorganic dielectric material and disposed inside the outer layer contributes to accumulating the electric charges at the interface and prevents the charges from flowing to the substrate.

As a result, the accumulated charges can be stably held, and changes in the surface potential can be suppressed regardless of the temperature environment. This allows the electret to maintain its initial high surface potential and exhibit stable performance even in harsh environments. Furthermore, it becomes possible to apply high-temperature processes for producing power generation devices using electrets, thereby improving design flexibility and contributing to reducing manufacturing costs.

As described above, according to the above-mentioned embodiment, it is possible to provide an electret that can maintain a high surface potential for a long period even in a high-temperature environment and has excellent thermal and temporal stability.

The reference signs in parentheses described in the claims and the solutions to problems indicate a correspondence relationship with specific means described in the embodiments to be described later, and do not limit the technical scope of the present disclosure.

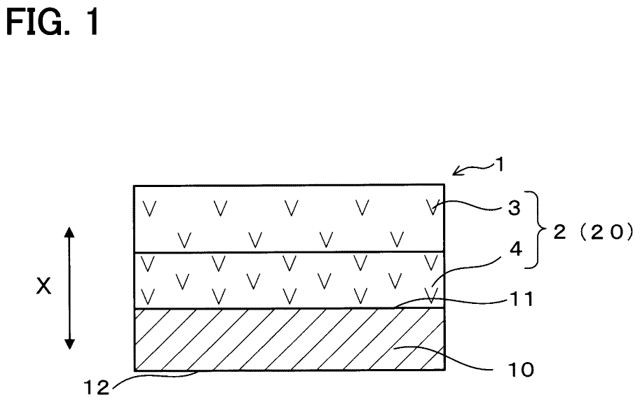

(First Embodiment) An electret according to a first embodiment will be described with reference to drawings. As shown in FIG. 1, the electret 1 of the present embodiment has a substrate 10 and an electret layer 2 formed on a surface of the substrate 10. The electret layer 2 is an inorganic dielectric layer 20 that has been subjected to a charging treatment to be turned into an electret. The inorganic dielectric layer 20 includes an outer layer 3 and an inner layer 4 that are stacked in a thickness direction X of the substrate 10. The outer layer 3 is a layer containing as a main component a first inorganic dielectric material, and the inner layer 4 is a layer containing as a main component a second inorganic dielectric material.

The outer layer 3 of the inorganic dielectric layer 20 is located on the outer side in the thickness direction X of the substrate 10 (i.e., the stacking direction), and the inner layer 4 is located between the outer layer 3 and the substrate 10. The first inorganic dielectric material which is the main component of the outer layer 3 is selected from inorganic dielectric materials which are composite metal compounds each containing two or more different metal elements and having a bandgap energy of 3 eV or more. At least one of the metal elements is a trivalent metal element. The second inorganic dielectric material which is the main component of the inner layer 4 is selected from inorganic dielectric materials different from the first inorganic dielectric material.

The inorganic dielectric layer 20 can exhibit desired electret characteristics by appropriately selecting the combination of inorganic dielectric materials as the outer layer 3 and the inner layer 4, and thicknesses of the outer layer 3 and the inner layer 4, and the conditions for electretization (electret formation). In the film composition for the outer layer 3 and the inner layer 4, the term “main component” means that the constituent materials may be only the first or second inorganic dielectric materials, or may contain impurities originating from the raw materials of the first and second inorganic dielectric materials, or may contain small amounts of other components added during the process of forming the first and second inorganic dielectric materials.

The electret 1 is a charged substance that holds a positive or negative charge on its surface and provides an electrostatic field to its surroundings. When the inorganic dielectric layer 20 formed on the substrate 10 is subjected to a charging treatment, the inorganic dielectric layer 20 develops electret performance and becomes an electret layer 2. “Electretization” means, in other words, to make a substance into a charged substance by carrying out a charging treatment to develop a surface potential. The electret 1 is used, for example, as an integrated circuit embedded power generation element in various devices that mutually convert mechanical energy and electrical energy, such as small electrostatic vibration power generation devices driven by environmental vibration.

The composition of the first inorganic dielectric material constituting the outer layer 3 is not particularly limited as long as the first inorganic dielectric material is a composite metal compound material that includes different metal elements at least one of which is a trivalent metal element and has a bandgap energy of 3 eV or more. Desired physical properties can be obtained depending on the combination of the different metal elements and the structure of the composition containing the metal elements. For example, the relatively high bandgap energy of 3 eV or more, preferably 4 eV or more can be obtained depending on the combination of the metal elements and the structure of the composition, thereby achieving a high breakdown voltage. This enables application of a high voltage during the charging treatment, allowing a desired high surface potential to be developed. The first inorganic dielectric material may have a bandgap energy of 4.5 eV or more, or 5.5 eV or more.

In this embodiment, the electret layer 2 has a structure in which the inner layer 4 and the outer layer 3 are stacked in this order on the substrate 10. Since the outer layer 3 is made of the first inorganic dielectric material having a relatively large bandgap energy, a high surface potential can be developed. Furthermore, since the inner layer 4 made of the second inorganic dielectric material is disposed inside the outer layer 3, the generated charges are accumulated at the interface between the outer layer 3 and the inner layer 4. The charge accumulation effect at the interface of such a stacked structure is generally known as the Maxwell-Wagner effect. However, the combination of the outer layer 3 made of the first inorganic dielectric material and the inner layer 4 made of the second inorganic dielectric material exhibits an unprecedentedly high effect on the retention and stabilization of the amount of charge appearing on the surface of the outer layer 3.

With this configuration, it has been found that the electret 1 can almost maintain its initial surface potential even in high-temperature environments exceeding 200° C., as before being exposed to such conditions. The electret 1 can exhibit stable performance even in applications with harsh temperature conditions.

A specific configuration example of the electret 1 will be described in detail below. The electret 1 has any outer shape according to the shape of the substrate 10. The shape of the substrate 10 is, for example, a rectangular plate shape or a disk shape. Multiple layers as the inorganic dielectric layers 20, which are to be the electret layer 2, are stacked on one surface of the substrate 10 in the thickness direction (here, the up-down direction in the figure). That is, the outer shapes of the outer layer 3 and the inner layer 4 which are the multiple layers are substantially the same as that of the substrate 10. The stacked direction of the outer layer 3 and the inner layer 4 is the same as the thickness direction X of the substrate 10. Hereinafter, the surface of the substrate 10 on which the electret layer 2 is stacked is referred to as an upper surface 11 and the opposite layer of the substrate 10 is referred to as a lower surface 12.

The first inorganic dielectric material forming the outer layer 3 may have a basic composition of a composite oxide containing two different metal elements A and B. In this case, the metal elements A and B are selected so that the bandgap energy is 3 eV or more, and at least one of the metal elements A and B contains a trivalent metal element. Preferably, the metal element A is a divalent or trivalent metal element, and the metal element B is a trivalent metal element.

An example of such first inorganic dielectric material is a composite oxide having a perovskite type composition. That is, the first inorganic dielectric material may have a basic composition of a first composite oxide that includes two different trivalent metal elements A and B and expressed by a composition formula of ABO₃. The composite oxide having a perovskite type composition is typically a composite oxide having a perovskite type crystal structure with a cubic unit cell. In this crystal structure, the metal element A (A site) is located at each vertex of the cubic cell, the metal element B (B site) is located at the center of the cubic cell, and oxygen atoms O are coordinated to each of the metal elements A and B in a regular octahedron. In the perovskite structure, a non-stoichiometric composition is often obtained due to a deficiency of oxygen atoms. In such a case, the composition can be expressed by the composition formula ABOₓ (x≤3).

Here, the first composite oxide needs to have a basic composition represented by the composition formula ABO₃, and may be either crystalline having a perovskite type crystal structure or amorphous. In either case, it is desirable that the ratio of the metal elements A, B, and O, which are the basic constituent elements, of the first composite oxide as a whole is A:B:O=1:1:3 or close to this. In this case, when the amount of oxygen is less than the stoichiometric ratio of the basic composition, defects are likely to be introduced and the surface potential is likely to increase.

The form of the outer layer 3 of the electret layer 2 which mainly contains the first inorganic dielectric material is not particularly limited, and may be a layer of the first composite oxide having an amorphous structure (hereinafter referred to as an amorphous layer) or a layer of the first composite oxide having a crystalline structure (hereinafter, referred to as an oxide crystal layer). In this case, it is not necessary for the entire outer layer 3 to be an oxide with a uniform composition. The outer layer 3 may have regions with compositions different from the basic composition.

In the present embodiment, the electret layer 2 having an amorphous layer as the outer layer 3 will be mainly described below. In the amorphous layer, defects due to dangling bonds in an unbonded state are likely to be formed compared with an oxide crystal having a perovskite structure of the same composition. In the electret layer 2, it is considered that the presence of defects is important for the expression of the surface potential. Thus, a high surface potential can be obtained by using the amorphous layer. Further, since the amorphous layer can be formed at a lower temperature than the oxide crystal layer, it is possible to suppress thermal damage to wiring and the like during a device formation.

The first composite oxide serving as the first inorganic dielectric material preferably has a composition expressed as the composition formula ABO₃, where the metal element A is at least one element selected from rare earth elements R, and the metal element B is aluminum. Since a perovskite type composite oxide containing a trivalent rare earth metal element R and a trivalent Al (i.e., RAlO₃; rare earth aluminate) has a relatively large bandgap energy (e.g., 4 eV or more) and relatively small relative permittivity (e.g., 100 or less), a high surface potential can be realized. In addition, the rare earth aluminate can be manufactured using relatively inexpensive materials, which is advantageous in the manufacturing cost.

The trivalent rare earth element R may be at least one element selected from Y, Sc and lanthanoids. Examples of lanthanoids include La, Pr, Nd, Sm, and Gd. The perovskite type composite oxide is preferably LaAlO₃ (lanthanum aluminate) containing La as the trivalent rare earth element R and Al.

The first composite oxide may have the composition formula ABO₃, where some atoms of the metal element A, some atoms of the metal elements B, or both of them are substituted by a dopant element D that is different from the metal element A and the metal element B. In that case, when the dopant element D is a metal element having a lower valence than the metal elements A and B, defects due to oxygen vacancies are likely to occur in the structure. For example, when the metal element A is a trivalent rare earth element R, a divalent alkaline earth metal element is preferably used as the dopant element D, and when the metal element B is a trivalent Al, one or more elements selected from the group consisting of divalent alkaline earth metal elements and Zn are preferably used as the dopant element D. Examples of the alkaline earth metal elements include Mg, Ca, Sr, and Ba.

The combination of the metal elements A and B and the dopant element D is not particularly limited. Substitution of the metal element A and/or the metal element B with the lower valence dopant element D creates defects due to oxygen deficiency in the perovskite structure to maintain electrical neutrality, which contributes to the improvement of the surface potential. Since there is a correlation between the substitution amount with the dopant element D and the number of defects, it is possible to control the number of defects that affect the surface potential by controlling the introduced amount of the dopant element D, so that a stable surface potential characteristics can be obtained.

Specifically, lanthanum aluminate (LaAlO₃) can be mentioned as a typical example of the rare earth aluminate, and a structure in which some of La atoms substituted with an alkaline earth metal element (for example, Ca) can be used. In that case, the composition of the structure can be expressed by the formula (La, Ca)AlOₓ (x<3) taking into consideration the substitution amount by the dopant element D and the amount of oxygen that varies depending on the atmosphere. Alternatively, for convenience, the basic composition formula before substitution may be used. For example, when only the dopant element D is taken into consideration, and the substitution ratio is Y (atm %), the composition formula can be expressed as La_{(1-Y)}Ca_{Y}AlO_{3-Y/2}.

The substitution ratio of the dopant element D for the metal element A can be appropriately set in the range equal to or less than 20 atm %, preferably in the range between 0.5 atm %, inclusive, and 20 atm %, inclusive. Similarly, the substitution ratio of the dopant element D for the metal element B is in the range equal to or less than 20 atm %, preferably in the range between 0.5 atm %, inclusive, and 20 atm %, inclusive. When the substitution ratio is 0.5 atm % or more, the surface potential is improved as compared with the case where the dopant element D is not introduced. However, when the substitution ratio approaches 20 atm %, the effect of introducing the dopant element D tends to decrease. The reason for this is not entirely clear, but it is presumed that an increase in the relative permittivity acts to lower the surface potential. Thus, it is preferable to appropriately set the substitution ratio within the range where the substitution ratio does not exceed 20 atm % so that the desired characteristics can be obtained.

In the electret layer 2, it is desirable that the relative permittivity of the first inorganic dielectric material which is the main component of the outer layer 3 is greater than the relative permittivity of the second inorganic dielectric material which is the main component of the inner layer 4. The relative permittivity of the first inorganic dielectric material can be adjusted, for example, by the combination of the metal elements A and B, the dopant element D introduced in place of the metal elements A and B, and the substitution ratio of the dopant element D. The relative permittivity is an inherent value expressed as the ratio between the dielectric constant of each material and the dielectric constant of a vacuum (i.e., relative permittivity=dielectric constant ε/dielectric constant of vacuum ε0).

In the electret layer 2, the outer layer 3 forming the outer surface exhibits a high surface potential, and the inner layer 4 interposed between the outer layer 3 and the substrate 10 contributes to a high charge accumulation effect at the interface between the outer layer 3 and the inner layer 4. This is thought to stabilize the surface potential. In this case, the outer layer 3 made of a material with a relatively large relative permittivity contributes to an increase in the amount of charge through the charging treatment, and the inner layer 4 made of a material with a relatively small relative permittivity suppresses the movement of the charges and contributes to stabilizing the charges accumulated at the interface.

This configuration prevents the charges accumulated in the electret layer 2 from flowing out through the substrate 10, making it possible to maintain the surface potential developed by the charging treatment even in a high-temperature environment. The relative permittivity of the first inorganic dielectric material is not particularly limited, but is preferably 10 or more to achieve a high surface potential (for example, 1000 V or more in absolute value). The upper limit of the relative permittivity is not particularly limited, but may be, for example, about 100 or less. The first inorganic dielectric material can be selected to achieve a desired surface potential and a bandgap energy.

The second inorganic dielectric material is not particularly limited, and can be appropriately selected from inorganic dielectric materials having a smaller relative permittivity than the first inorganic dielectric material. Preferably, the second inorganic dielectric material is an inorganic compound having a relative permittivity of about 10 or less. Examples of such inorganic compounds include oxides, nitrides, and oxynitrides containing a metal element such as Si or Al, and mixtures of them. Preferred examples of such inorganic compounds include Si compounds such as SiO₂ and SiN, Al compounds such as AlOₓ (e.g., Al₂O₃), or a mixture of two or more compounds selected from the Si compounds and Al compounds. The second inorganic dielectric material can be appropriately selected from these compounds in consideration of the first inorganic dielectric material, the material of the substrate 10, the method of forming layers on the substrate 10, and the like.

The material of the substrate 10 is not particularly limited, and may be, for example, conductive Si. Alternatively, the substrate 10 may be a conductive substrate using a conductive material such as (Nb, Sr)TiO₃ or a metal, or an insulating substrate using an insulating material such as Al₂O₃ or a glass material.

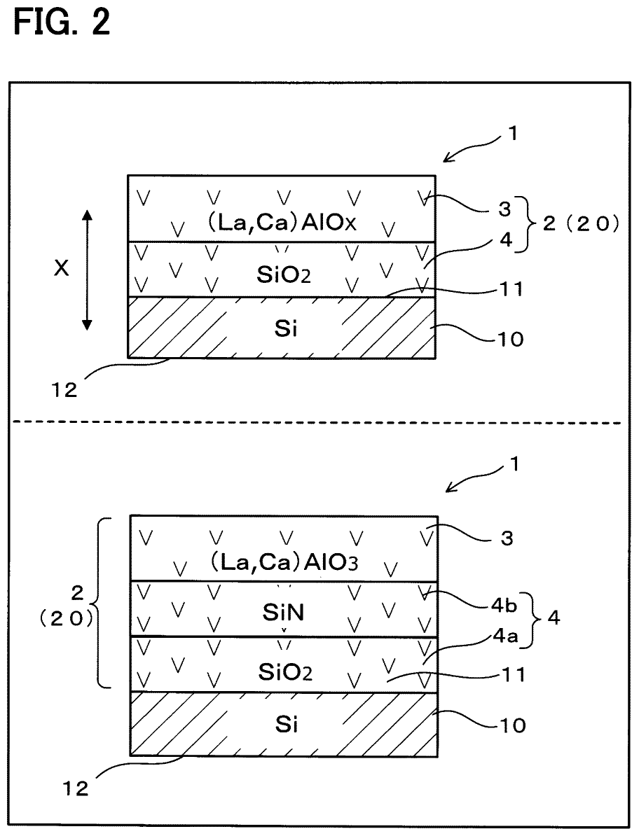

As shown in the upper diagram of FIG. 2, the first inorganic dielectric material constituting the outer layer 3 of the electret layer 2 may be a first composite oxide represented by the composition formula of (La, Ca)AlOₓ (x<3), and the second inorganic dielectric material constituting the inner layer 4 may be SiO₂. The inorganic dielectric layer 20 that includes the outer layer 3 and inner layer 4 described above is formed directly on the upper surface 11 of the substrate 10 that is made of conductive Si, for example. Then, the inorganic dielectric layer 20 is electretized to become the electret 1 having an overall three-layer structure.

As shown in a modified example shown in the lower diagram of FIG. 2, the electret layer 2 may have the inner layer 4 having a multi-layer structure of two or more layers. The inner layer 4 may be configured to have multi-layer structure (hereinafter, referred to as multi-layer film. In this case, two or more of the metal compounds exemplified as the second inorganic dielectric material may be arbitrarily combined. Here, the inner layer 4 is a multi-layer film having a first layer 4a (e.g., SiO₂) in contact with the upper surface 11 of the substrate 10, and a second layer 4b (e.g., SiN).

The method for forming the thin films as the inorganic dielectric layer 20 is not particularly limited, and any method can be used. Specifically, the film forming method may be selected from a physical vapor deposition method (PVD method) such as a sputtering method, a chemical vapor deposition method (CVD method), a welding method, and a sol-gel method in consideration of the target quality and thickness of each of the outer layer 3 and the inner layer 4 that constitute the inorganic dielectric layer 20.

For example, when the sputtering method is used as a method for forming the outer layer 3 and the inner layer 4, crystals of the first and second inorganic dielectric materials having the same composition as the target layer are used as targets, and a high voltage is applied in an inert gas to cause accelerated ions to collide with the targets, thereby forming a thin film of the desired composition on the upper surface of the substrate 10. Additionally, as shown in FIG. 2, when the second inorganic dielectric material constituting the inner layer 4 contains SiO₂, a thermal oxidation film of SiO₂ can be formed on the surface of the Si substrate, which is the substrate 10, through a thermal oxidation method.

The film formation temperature is usually in the range of room temperature to 1000° C. and may be a temperature according to the material. By forming the film under a temperature condition of 1000° C. or lower using such a method, it is possible to form the thin films of the first and second inorganic dielectric materials to be the inorganic dielectric layer 20 while suppressing damage to the substrate 10 and wiring on the substrate 10 due to high temperature. The first and second inorganic dielectric materials used as the target raw materials may be produced through a high temperature process exceeding 1000° C.

The thickness of the thin film formed on the substrate 10 can be adjusted to any value, for example, 0.01 μm or more, by adjusting the film formation conditions. Preferably, for example, by forming the inorganic dielectric layer 20 to have the thickness in the range of 0.1 μm to 10 μm, the electret 1 suitable for a small device such as a vibration power generation element or a memory circuit can be obtained. At this time, the surface potential of the electret layer 2 has a positive correlation with the thickness of the inner layer 4. The inner layer 4 exhibits a characteristic that the thicker the inner layer 4, the higher the surface potential is. The thickness of the inner layer 4 is preferably adjusted to a range of 0.1 μm or more, more preferably 0.5 μm or more to obtain desired characteristics.

On the other hand, the surface potential of the electret layer 2 does not depend on the thickness of the outer layer 3, and is almost constant since the inner layer 4 is interposed between the electret layer 2 and the substrate 10. Thus, the thickness of the outer layer 3 needs to be 0.01 μm or more, and preferably 0.1 μm or more, to achieve a surface potential according to the composition, charging conditions, and the like. More preferably, the thickness of the outer layer 3 is adjusted to a sufficient thickness within the range of 0.5 μm or more so that dielectric breakdown does not occur due to the applied voltage during the charging treatment.

The electret 1 is obtained by performing the charging treatment in the stacking direction (i.e., the thickness direction X) to the inorganic dielectric layer 20 formed on the upper surface 11 of the substrate 10. The charging method is not particularly limited, and may be a method in which a voltage is applied under heating conditions between a grounded electrode connected to the inorganic dielectric layer 20 and an opposing electrode using corona discharge or the like. Alternatively, the charging method may be a thermal electretization method in which a high voltage is applied at a high temperature.

Here, since the surface potential is proportional to a voltage applied to the inorganic dielectric layer 20 formed on the substrate 10, a voltage that realizes the required surface potential according to the application may be applied. Alternatively, the film thickness may be increased to prevent dielectric breakdown at the required voltage.

(Second Embodiment) An electret according to a second embodiment will be described. The basic configuration of the electret 1 of the present embodiment is the same as that of the first embodiment, and includes the substrate 10 and the electret layer 2 formed on the substrate 10. The electret layer 2 has a two-layer structure having an outer layer 3 and an inner layer 4. In this embodiment, the first inorganic dielectric material which is the main component of the outer layer 3 is changed. Hereinafter, the differences will be mainly described. Those of reference numerals used in the second and subsequent embodiments which are the same reference numerals as those used in the above-described embodiment denote the same components as in the previous embodiments unless otherwise indicated.

The form of the outer layer 3 constituting the electret layer 2 is the same as that of the first embodiment, and can be an amorphous layer or an oxide crystal layer containing the first inorganic dielectric material as a main component. The material of the substrate 10, the second inorganic dielectric material constituting the inner layer 4, the film formation method, film thickness, and other factors can be the same as those in the first embodiment.

In this embodiment as well, the first inorganic dielectric material includes, as a basic composition, a composite oxide having a band gap energy of 3 eV or more and at least one of the metal elements A and B is a trivalent metal element. Preferably, the first inorganic dielectric material is a composite oxide containing a divalent or trivalent metal element A and a trivalent metal element B. As such a composite oxide, a second composite oxide having a garnet-type composition or a third composite oxide having a spinel-type composition can be used instead of the composite oxide having a perovskite-type composition of the first embodiment.

Alternatively, the first inorganic dielectric material may include, as a basic composition, the second composite oxide that is expressed by the composition formula of ABO₃ and contains two different trivalent metal elements A and B. In this case, the second composite oxide may be crystalline having a cubic garnet-type crystal structure or amorphous. In either case, it is desirable that the ratio of the metal elements A, B, and O, which are the basic constituent elements, of the second composite oxide as a whole is A:B:O=3:5:12 or close to this.

In the second composite oxide, the combination of the trivalent metal elements A and B is not particularly limited. Preferably, as in the first composite oxide having a perovskite type composition, in the composition formula of A₂B₅O₁₂, the metal element A is at least one element selected from the rare earth elements R and the metal element B is Al. The trivalent rare earth element R may be at least one element selected from Y, Sc and lanthanoids. Examples of lanthanoids include La, Pr, Nd, Sm, and Gd. A specific example of the second composite oxide having such a composition is Y₃Al₅O₁₂, which contains Y as the trivalent rare earth element R and Al.

In the composition formula of A₃B₅O₁₂, the metal element A may be a combination of two or more rare earth elements. Alternatively, as the metal element B, Al and at least one element selected from the trivalent typical elements (for example, Ga) can be used in combination. A specific example of the second composite oxide having such a composition is Gd₃(Al,Ga)₅O₁₂ containing Gd as the trivalent rare earth element R, and Al and Ga.

In the composition formula of A₃B₅O₁₂, some atoms of the metal element A, some atoms of the metal element B, or both of them may be substituted by a dopant element D that is different from the metal element A and the metal element B. In this case, it is preferable that the dopant element D is a metal element having a lower valence than the metal elements A and B. For example, when the metal element A is a trivalent rare earth element R, a divalent alkaline earth metal element is preferably used as the dopant element D, and when the metal element B is a trivalent Al, one or more elements selected from the group consisting of divalent alkaline earth metal elements and Zn are preferably used as the dopant element D. Examples of the alkaline earth metal elements include Mg, Ca, Sr, and Ba.

The substitution ratio of the dopant element D for the metal elements A and B can be appropriately set, for example, to 20 atm % or less, preferably within the range between 0.1 atm %, inclusive, and 20 atm %, inclusive. More preferably, when the substitution ratio is 0.5 atm %, defects are easily introduced, which contributes to improving the surface potential. Thus, it is preferable to appropriately set the substitution ratio within the range less than 20 atm % to achieve the desired characteristics.

Alternatively, the first inorganic dielectric material may have, as a basic composition, a third composite oxide represented by the composition formula of AB₂O₄ and containing a divalent metal element A and a trivalent metal element B. In this case, the third composite oxide may be crystalline having a cubic spinel type crystal structure or amorphous. In either case, it is desirable that the ratio of the metal elements A, B, and O, which are the basic constituent elements, of the third composite oxide as a whole is A:B:O=1:2:4 or close to this.

In the third composite oxide, the combination of the divalent metal element A and the trivalent metal element B is not particularly limited. Preferably, in the composition formula AB₂O₄, the divalent metal element A is at least one element selected from alkaline earth metal elements and transition metal elements, and the trivalent metal element B is Al. Examples of the alkaline earth metal elements include Mg, Ca, Sr, and Ba. Examples of the transition metal elements include Fe, Zn, and Mn.

Specific examples of the third composite oxide having such a composition include MgAl₂O₄ (spinel type), SrAl₂O₄, FeAl₂O₄, ZnAl₂O₄, MnAl₂O₄, and the like. All of them have a relatively high bandgap energy (e.g., 4 eV or more).

In this embodiment as well, the inorganic dielectric layer 20 includes the outer layer 3 of the second composite oxide or third composite oxide as the first inorganic dielectric material and the inner layer 4. It is not necessary for the entire outer layer 3 to be an oxide with a uniform composition. The outer layer 3 may have regions with compositions different from the second or third composite oxide as the basic composition. The electret layer 2 is obtained by subjecting such inorganic dielectric layer 20 to a charging treatment. The charging method can be the same as that in the first embodiment.

Like the first composite oxide, the second and third composite oxides may have defects in their structures due to oxygen deficiency or the like, and may have a lower oxygen content than that of the basic composition formula. In that case, the composition can be expressed as A₃B₅Oₓ (x≤12) or AB₂Oₓ (x≤4). Alternatively, for convenience, the basic composition formula before substitution is used.

Specifically, for example, in the second composite oxide expressed by Y₃Al₅O₁₂, some of the Y atoms may be substituted with an alkaline earth metal element (for example, Mg) as a dopant element D. In that case, the composition can be expressed by the formula (Y, Mg)₃Al₅Oₓ (x<12) taking into consideration the amount of oxygen substituted with the dopant element D and the amount of oxygen that varies depending on the atmosphere. Alternatively, for convenience, the basic composition formula before substitution may be used also in this case.

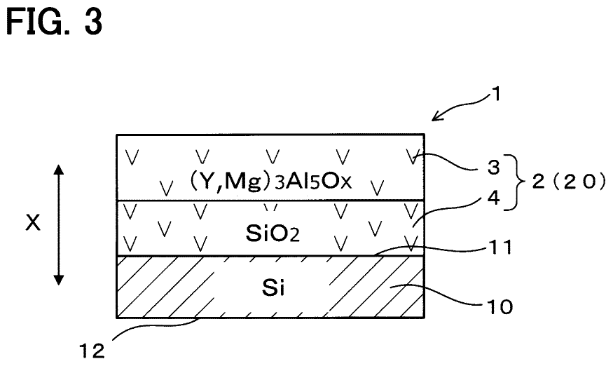

In this case, as shown the electret layer 2 in FIG. 3, the first inorganic dielectric material constituting the outer layer 3 may be the second composite oxide represented by the composition formula (Y, Mg)₃Al₅Oₓ (x<12), and the second inorganic dielectric material constituting the inner layer 4 may be SiO₂. The inorganic dielectric layer 20 that includes the outer layer 3 and the inner layer 4 described above is formed directly on the upper surface 11 of the substrate 10 that is made of conductive Si, for example. Then, the inorganic dielectric layer 20 is electretized to become the electret 1 having an overall three-layer structure.

In the second and third composite oxides as the first inorganic dielectric material in this embodiment, the molar fraction of the metal element B relative to the total of the metal elements A and B is greater than that of the first composite oxide. That is, the first composite oxide having a perovskite composition, which is used in the first embodiment, has an equal ratio of metal element A and metal element B (i.e., A:B=1:1), whereas the second composite oxide having a garnet composition has a ratio of A:B=3:5, and the third composite oxide having a spinel composition has a ratio of A:B=1:2. That is, the proportion of the metal element B in the second and third composite oxides is higher than in the first composite oxide.

The basic composition of the first inorganic dielectric material is any one of the first to third composite oxides that include the metal elements A, B, and O as the basic constituent elements, with the ratio A:B:O being in a predetermined relationship. These first to third composite oxides exhibit the desired properties, such as a band gap energy of 3 eV or more and a relative permittivity of 100 or less according to combination of the different metal elements A and B or introduction of the dopant element D. The relative permittivity of the first to third composite oxides is higher than the relative permittivity of the second inorganic dielectric material. The inorganic dielectric layer 20, which is a combination of the first and second inorganic dielectric materials, develops a high surface potential through electretization, and stably maintains the developed surface potential.

(Working Example 1) An electret 1 having the configuration of the first embodiment shown in FIG. 2 (the upper diagram) was prepared by the following method. As the first inorganic dielectric material, a first composite oxide having a perovskite type composition was used.

<Formation of Inorganic dielectric layer 20> First, the upper surface 11 of the substrate 10 made of conductive Si was thermally oxidized to form a thermal oxide layer (SiO₂), which was used as the inner layer 4 made of a thin film of the second inorganic dielectric material. The thickness of the substrate 10 was 625 μm, and the thickness of the inner layer 4 was 1.2 μm. Next, the outer layer 3 made of a first inorganic dielectric material was formed on the upper surface of the inner layer 4 by sputtering. The sputtering conditions were 360° C. in an Ar atmosphere. A crystal having the same composition as the first composite oxide used as the first inorganic dielectric material was used as a target to deposit an amorphous layer to form the outer layer 3 with a thickness of 1.3 μm.

The first composite oxide was a lanthanum aluminate (LaAlO₃; LAO)-based composite oxide containing La and Al as the metal elements A and B in the composition formula ABO₃, with some atoms of La being substituted with a dopant element D. Here, Ca was used as the dopant element D, and the substitution ratio was set to 1 atm % (hereinafter, appropriately referred to as LAO with 1% Ca added). Also, as a target, a polycrystalline body [(La_{0.99}Ca_{0.01})AlOₓ] was prepared in advance by forming an LAO-based composite oxide containing 1 atm % of Ca into a predetermined shape and sintering it. In this manner, an amorphous layer containing Ca, La, Al, and O in the ratio of La, Al, and O was approximately 1:1:3 was obtained.

Lanthanum aluminate (LaAlO₃), which is a typical composition of the LAO-based inorganic dielectric material, has a bandgap energy of 5.6 eV, and even a configuration in which some atoms of La are substituted by atoms of Ca, which is a dopant element, has almost the same bandgap energy. Furthermore, the relative permittivity of the LAO-based composite oxide (i.e., the first inorganic dielectric material) is about 22, which is greater than that of SiO₂ (i.e., the second inorganic dielectric material) having a relative permittivity of 3.8.

<Electretization> In this manner, a sample was prepared in which the inorganic dielectric layer 20 was formed on the substrate 10, and then the sample was subjected to a charging treatment to obtain an electret 1 having the electret layer 2 (the working example 1). The charging treatment employed a corona discharge method. In this method, the substrate 10 in contact with the inner layer 4 of the inorganic dielectric layer 20 was used as a ground electrode, a discharge needle serving as a corona discharge electrode was placed to face the outer layer 3, and a negative voltage was applied to generate a corona discharge. At this time, the sample was placed on a heater plate so that the lower surface 12 of the substrate 10 was in contact with the heater plate. The heating temperature by the heater plate and the conditions for the charging treatment by corona discharge were as follows. Heating temperature: 200° C., Discharge needle voltage: −10 kV, Discharge time: 15 seconds, Distance between discharge needle and sample: 20 mm.

<Surface Potential Measurement> As a result, ions charged by the corona discharge collide with the exposed surface of the inorganic dielectric layer 20 formed on the substrate 10 (i.e., the surface of the outer layer 3), and become negatively charged, thereby erectretizing the inorganic dielectric layer 20. Next, the surface potential of the electret 1 of the working example 1 obtained as described above was measured. For the measurement, a surface potential meter (MODEL 341-B, manufactured by Trek Corporation) was used, and a measurement probe was placed to face the electret 1 placed on a stage to measure the surface potential in a non-contact manner. In this case, multiple samples (number of samples n=2) of the same configuration were prepared, each was subjected to the charging treatment, and then subjected to a heat treatment at 200° C. for 30 minutes. The surface potential after the heat treatment was measured, and all of them expressed a high surface potential of more than 1100 V (absolute value).

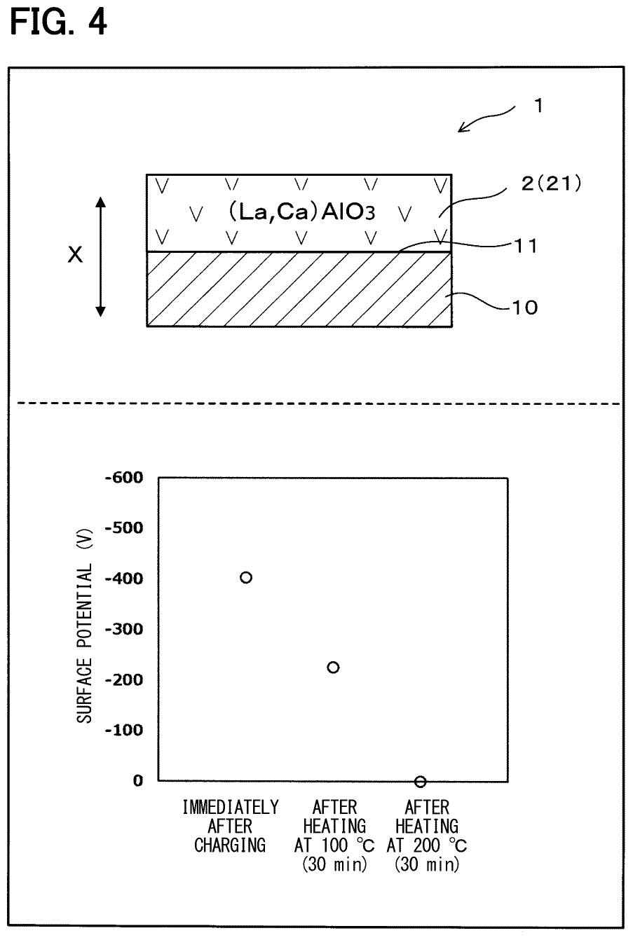

(Comparative Example 1) For comparison, an electret 1 was produced using a single-layer inorganic dielectric layer 21 as shown in FIG. 4 (the upper diagram). The inorganic dielectric layer 21 as the electret layer 2 has a configuration mainly composed of the same inorganic dielectric material as the outer layer 3. That is, the electret layer 2 is a single layer without the inner layer 4 in the configuration of the working example 1. Others were the same as those in the working example 1. Specifically, the electret 1 of the comparative example 1 was formed by depositing an amorphous layer of the LAO-based composite oxide with 1 atm % of Ca added directly on the upper surface 11 of the substrate 10 made of conductive Si by a sputtering method to form the inorganic dielectric layer 21. Then, the formed inorganic dielectric layer 21 was subjected to the charging treatment in the same manner of the working example 1. The thickness of the substrate 10 was 625 μm, and the thickness of the inorganic dielectric layer 21 was 1.3 μm.

The surface potential immediately after the charging treatment was measured for the electret of the comparative example 1 in the same manner as in the working example 1. At this time, the effects of the thermal environment and the passage of time on the surface potential were evaluated by heating the electret 1 at 100° C. or 200° C. for 30 minutes immediately after the electretization by the charging treatment, and measuring the surface potential of them. The lower graph in FIG. 4 shows the respective results immediately after the charging treatment, after heating at 100° C. for 30 min, and after heating at 200° C. for 30 min.

In the lower graph in FIG. 4, the surface potential immediately after the charging treatment is about 400 V (absolute value), which is less than half the surface potential in the working example 1. Moreover, the surface potential after heating at 100° C. is around 200 V (absolute value), which is half the surface potential immediately after the charging treatment. The surface potential after heating at 200° C. was further reduced and almost disappeared. In this manner, it is confirmed that when the electret layer 2 formed on the substrate 10 is formed of a single layer of the inorganic dielectric layer 21, it is difficult to maintain the surface potential in a high temperature environment.

(Working Examples 2 to 5) Next, electrets 1 of the working examples 2 to 5 were prepared that have the same stacked structure of the electret layer 2 with the working example 1, but have different thickness of the inner layer 4. Specifically, the thermal oxide layer (SiO₂) serving as the inner layer 4 was formed on the upper surface 11 of the substrate 10 (i.e., conductive Si) with a thickness of 0.1 μm, 0.3 μm, 0.5 μm, or 1.0 μm. Then, an amorphous layer (i.e., LAO with 1% Ca added) serving as the outer layer 3 was formed by a sputtering method to form the inorganic dielectric layer 20. Thereafter, each of the samples was subjected to a charging treatment in the same manner as in the working example 1 to obtain electrets 1 of the working examples 2 to 5. The thickness of the substrate 10 was 625 μm, and the thickness of the outer layer 3 was 1.3 μm.

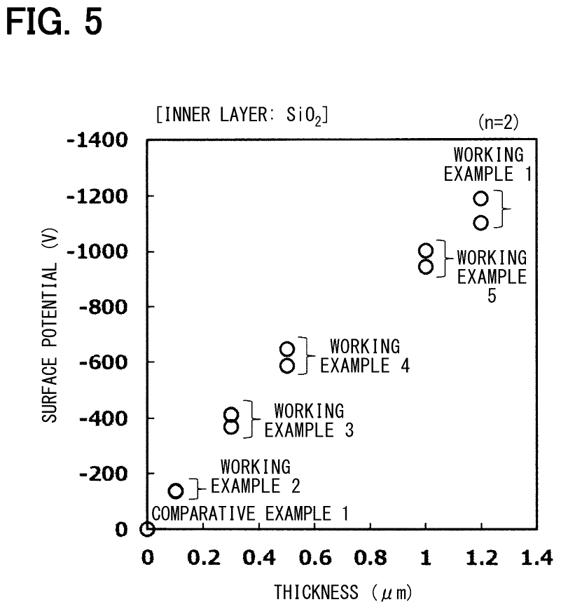

The surface potentials of the electrets of the working examples 2 to 5 were measured in the same manner as in the working example 1. At this time, multiple samples (the number of samples n=2) were prepared for each working example, and after a charging treatment, they were heated at 200° C. for 30 minutes, and the surface potentials after the heating treatment were measured. Similarly, the surface potential of the electret 1 of the working example 1 was measured after heating at 200° C. for 30 minutes, and the results are shown in FIG. 5.

In FIG. 5, the horizontal axis represents the thickness of the inner layer 4 (i.e., SiO₂). FIG. 5 also shows the results of the comparative example 1, which does not have the inner layer 4. That is, when the thickness of the inner layer 4 is 0 μm, the surface potential is 0 V. In contrast, in the working examples 1 to 5 having the inner layer 4, the surface potential (absolute value) of about 140 V was obtained at 0.1 μm (the working example 2), and the surface potential increased in proportion to the thickness of the inner layer 4. Specifically, a high surface potential of about 400 V was obtained at 0.3 μm (the working example 3), about 600 V at 0.5 μm (the working example 4), and about 1000 V at 1.0 μm (the working example 5).

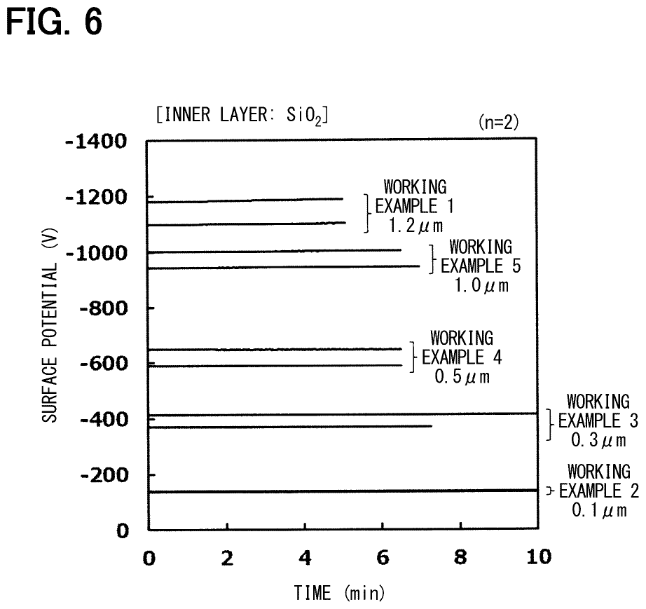

FIG. 6 shows the change in the surface potential of each sample of the electrets 1 of the working examples 1 to 5 when the samples were left at room temperature after the heating treatment. At this time, the surface potential of the sample just after the heating treatment was determined as the surface potential at the start of the test (elapsed time: 0), and the change in the surface potential was measured until a predetermined time had elapsed (for example, about 5 to 10 minutes). As shown in FIG. 6, all the working examples 1 to 5 show almost no change in the surface potential over time.

The results shown in FIGS. 5 and 6 indicate that the surface potential is maintained even after the heating treatment at 200° C. when the electret layer 2 has a layered structure of the outer layer 3 and the inner layer 4 (the working examples 1 to 5). Unlike comparative example 1, no disappearance of the surface potential was observed. In the range of thicknesses of the inner layer 4 from 0.1 μm (the working example 2) to 1.2 μm (the working example 1), the thicker the inner layer 4, the higher the surface potential, and no change in the surface potential was observed over time.

(Working Examples 6 and 7) Next, electrets 1 of the working examples 6 and 7 were prepared in which the thickness of the outer layer 3 was changed from the configuration of the electret layer 2 of the working example 2. Specifically, the thermal oxide layer (i.e., SiO₂) as the inner layer 4 was formed to have the thickness of 0.1 μm on the upper surface 11 of the substrate 10 (i.e., conductive Si), and then an amorphous layer (LAO with 1% Ca added) as the outer layer 3 was formed to have the thickness of approximately 0.4 μm by a sputtering method to form the inorganic dielectric layer 20. Thereafter, a charging treatment was performed to obtain the electret 1 of the working example 6. Additionally, the inorganic dielectric layer 20 was formed in the same manner except that the outer layer 3 was formed to have the thickness of approximately 0.9 μm, and the charging treatment was performed to obtain the electret 1 of the working example 7.

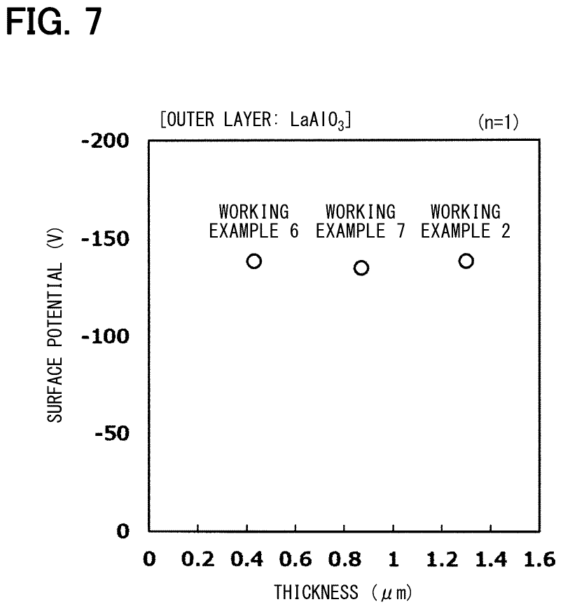

The electrets 1 of the working examples 6 and 7 were heated at 200° C. for 30 minutes after the charging treatment, and then the surface potential was measured in the same manner as in the working example 1. The results are shown in FIG. 7 in comparison with the results of the working example 2.

In FIG. 7, the surface potential (absolute value) of the working examples 6 and 7 were about 140 V, which was equivalent to the result of the working example 2. In this way, the magnitude of the surface potential does not depend on the thickness of the outer layer 3, and similar results can be obtained if the first inorganic dielectric material that constitutes the outer layer 3 is the same. As shown in the working examples 1 to 5, the magnitude of the surface potential has a positive correlation with the thickness of the inner layer 4, and thermally and temporally stable results are obtained for any thickness of the outer layer 3.

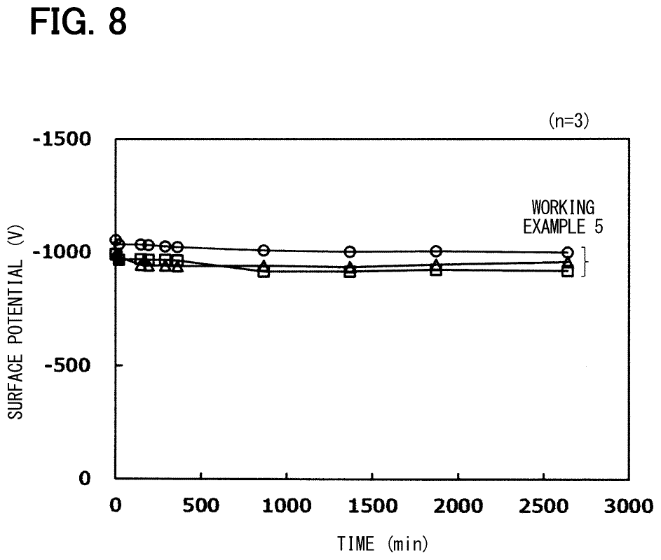

FIG. 8 shows the results of examining the change in the surface potential over time when the electret 1 of the working example 5 was stored for a longer period. Specifically, multiple samples (the number of samples n=3) of the same configuration were prepared, and each was subjected to a charging treatment and heated at 200° C. for 30 minutes. Then, the surface potential was measured. Furthermore, the surface potential was measured over time while the samples were stored in the atmosphere. The surface potential of each sample was measured at the same timing for up to about 2700 minutes.

In FIG. 8, the surface potential (absolute value) immediately after the heating treatment was about 1000 V in all the samples of the working example 5. The surface potential gradually decreased over time (for example, until 500 minutes), but the decrease was slight. Thereafter, almost no decrease in the surface potential was observed.

From these results, it can be seen that the electret 1 exhibits a surface potential depending on the combination of the outer layer 3 and the inner layer 4, which constitutes the electret layer 2, as well as the thickness of the inner layer 4. Additionally, the electret 1 suppresses the effects of the temperature environment and long-term storage, allowing for stable characteristics both thermally and over time.

(Working Examples 9 and 10) Next, electrets 1 of the working examples 9 and 10 were prepared in which the second inorganic dielectric material constituting the inner layer 4 was changed from the configuration of the electret layer 2 of the working example 1. Then, their thermal and temporal stability were examined. Specifically, a thin layer made of SiN was formed as the inner layer 4 on the upper surface 11 of the substrate 10 (i.e., conductive Si) by plasma CVD method. The formation by the plasma CVD method employed SiH₄ and NH₃ as source gases, and was performed under conditions of a substrate temperature of 300° C., to form a CVD thin layer made of SiN with a thickness of 0.3 μm.

On the upper surface of the inner layer 4, an amorphous layer (LAO with 1% Ca added) as the outer layer 3 was further formed by sputtering to have a thickness of 1.3 um, thereby forming the inorganic dielectric layer 20. Thereafter, a charging treatment was performed in the same manner as in the working example 1 to obtain the electret 1 of the working example 9. Moreover, the electret 1 of the working example 10 was prepared in the same manner, except that a CVD thin layer made of SiN having a thickness of 0.5 μm was formed as the inner layer 4.

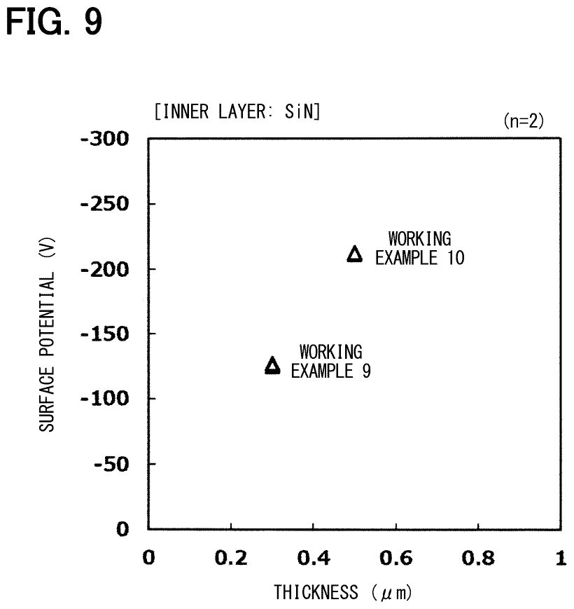

The surface potentials of the electrets of the working examples 9 and 10 were measured in the same manner as in the working example 1. At this time, multiple samples (the number of samples n=2) having the same configuration were prepared, and each was subjected to a charging treatment and heated at 200° C. for 30 minutes. Then, the surface potential was measured for each sample. The results are shown in FIG. 9.

In FIG. 9, the relationship between the thickness of the inner layer 4 and the surface potential is similar to that shown in FIG. 5, and as the thickness of the inner layer 4 increases from 0.3 μm (the working example 9) to 0.5 μm (the working example 10), the surface potential (absolute value) tends to increase from approximately 125 V to a value over 210 V. In this way, it is confirmed that regardless of the type of the second inorganic dielectric material that constitutes the inner layer 4, the thermal stability is improved and a stable surface potential is expressed with a positive correlation with the thickness of the inner layer 4.

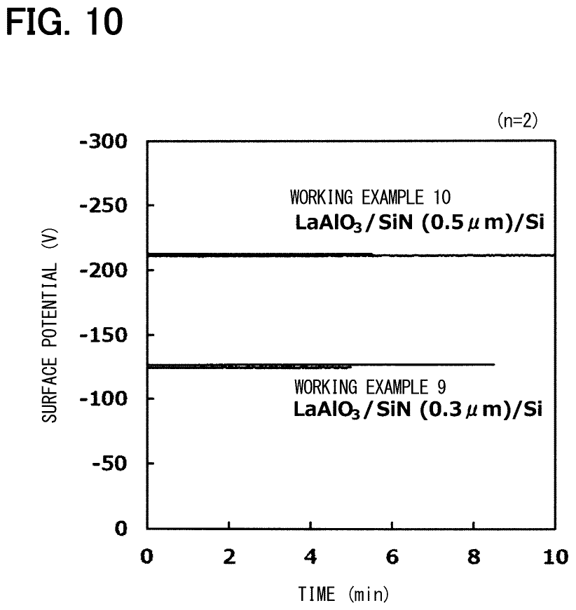

FIG. 10 shows the change in the surface potential when each sample of the electret 1 of the working examples 9 and 10 was left at room temperature after the heating treatment. At this time, the changes in the surface potential of the samples were observed over a specified period (e.g., 5 to 10 minutes), using the surface potential just after the heating treatment as the surface potential at the start of the test (elapsed time: 0). As shown in FIG. 10, almost no change in the surface potential was observed over time in both the working example 9 and the working example 10.

(Working Example 11) Next, the electret 1 of the second embodiment having the configuration shown in FIG. 3 was produced by the following method. As the first inorganic dielectric material, the second composite oxide having a garnet type composition was used.

First, in the same manner as in the working example 1, the upper surface 11 of the substrate 10 (i.e., conductive Si) was thermally oxidized to form a thermally oxidized layer (i.e., SiO₂) of the second inorganic dielectric material, which was used as the inner layer 4. The thickness of the substrate 10 was 625 μm, and the thickness of the inner layer 4 was 1.2 μm. Next, the outer layer 3 made of a first inorganic dielectric material was formed on the upper surface of the inner layer 4 by sputtering. The sputtering conditions were 360° C. in an Ar atmosphere. A crystal having the same composition as the second composite oxide used as the first inorganic dielectric material was used as a target to deposit an amorphous layer to form the outer layer 3 with a thickness of 0.6 μm. Thereby, the inorganic dielectric layer 20 was formed. Thereafter, a charging treatment was performed to obtain the electret 1 of the working example 11.

The second composite oxide was a Y₃Al₅O₁₂ (YAG)-based composite oxide containing Y and Al as the metal elements A and B in the garnet-type composition formula A₃B₅O₁₂, with some of the Y atoms being substituted by a dopant element D. Here, Mg was used as the dopant element D, and the substitution ratio was set to 4 atm % (hereinafter, appropriately referred to as YAG with 4% Mg added). As a target, a polycrystalline of the YAG-based composite oxide containing 4 atm % of Mg [Y_{2.88}Mg_{0.12}Al₅Oₓ] was prepared in advance. In this manner, the amorphous layer containing Mg, Y, Al, and O in the ratio of Y, Al, and O being approximately 3:5:12 was obtained.

Regarding the YAG-based composite oxide, Y₃Al₅O₁₂, which is the representative composition, has a band gap energy of about 5 eV. Even configurations in which some of the Y atoms are substituted by Ca, which is a dopant element, have almost the same bandgap energy. Furthermore, the relative permittivity of the YAG-based composite oxide (i.e., the first inorganic dielectric material) is about 12, which is greater than that of SiO₂ (i.e., the second inorganic dielectric material) having a relative permittivity of 3.8.

For the electret 1 of the working example 11, the surface potential was measured in the same manner as in the working example 1. At this time, multiple samples (the number of samples n=3) having the same configuration were prepared, and heated at 200° C. for 30 minutes after the charging treatment. Then, the surface potential after the heating treatment was measured. As a result, a high surface potential (absolute value) of about 900 V to 1200 V was obtained.

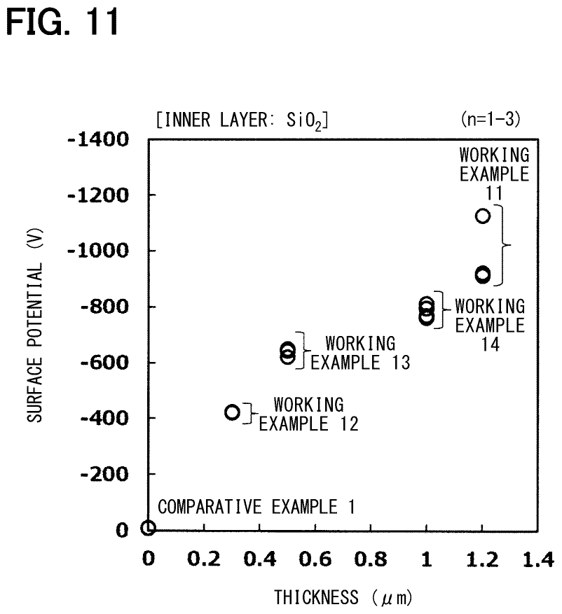

(Working Examples 12 to 14) In addition, electrets of the working examples 12 to 14 were prepared by changing the thickness of the inner layer 4 to 0.3 μm, 0.5 μm, and 1.0 μm from the electret of the working example 11, and forming the inorganic dielectric layer 20 in the same manner except for the thickness. The samples of the electrets 1 of the working examples 12 to 14 (the number of samples n=1 to 3) are heated at 200° C. for 30 minutes after the charging treatment in the same manner as in the working example 1. Then, the surface potential was measured. These results are shown in FIG. 11 together with the results of the working example 11 and the comparative example 1.

In FIG. 11, the surface potential (absolute values) of the working example 12 to 14 are approximately 400 V, 600 V, and 800 V, respectively, and the thermal stability is improved compared to the comparative example 1. The results of the working examples 11 to 14 show that the magnitude of the surface potential has a positive correlation with the thickness of the inner layer 4, and that a similar trend to that shown in FIG. 5 is observed even with the second composite oxide as the first inorganic dielectric material.

(Working Examples 15 and 16) Next, electrets 1 of the working examples 15 and 16 were prepared by changing the second inorganic dielectric material constituting the inner layer 4 to examine their thermal and temporal stability. Specifically, a thin layer made of SiN was formed as the inner layer 4 on the upper surface 11 of the substrate 10 (i.e., conductive Si) by a plasma CVD method. The formation by the plasma CVD method employed SiH₄ and NH₃ as source gases, and was performed under conditions of a substrate temperature of 300° C., to form a CVD thin layer made of SiN with a thickness of 0.3 μm.

On the upper surface of the inner layer 4, an amorphous layer (i.e., YAG with 4% Mg added) as the outer layer 3 was further formed by sputtering to have a thickness of 0.6 μm, thereby forming the inorganic dielectric layer 20. Thereafter, a charging treatment was performed in the same manner as in the working example 11 to obtain the electret 1 of the working example 11. Moreover, the electret 1 of the working example 16 was prepared in the same manner, except that a CVD thin layer made of SiN having a thickness of 0.5 μm was formed as the inner layer 4.

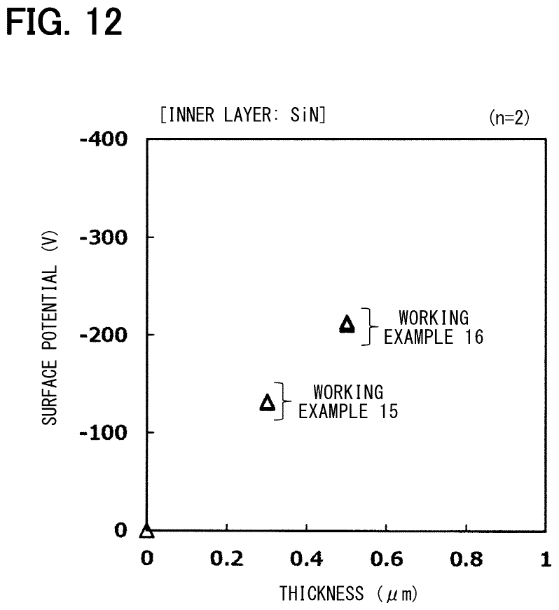

The surface potentials of the electrets of the working examples 15 and 16 were measured in the same manner as in the working example 1. At this time, multiple samples (the number of samples n=2) having the same configuration were prepared, and each was subjected to a charging treatment and heated at 200° C. for 30 minutes. Then, the surface potential was measured. The results are shown in FIG. 12.

In FIG. 12, the relationship between the thickness of the inner layer 4 and the surface potential is similar to that shown in FIG. 9, and as the thickness of the inner layer 4 increases from 0.3 μm (the working example 15) to 0.5 μm (the working example 16), the surface potential (absolute value) tends to increase from approximately 120 V to a value over 200 V. It is confirmed that regardless of the type of the second inorganic dielectric material that constitutes the inner layer 4, the thermal stability is improved and a stable surface potential is expressed with a positive correlation with the thickness of the inner layer 4.

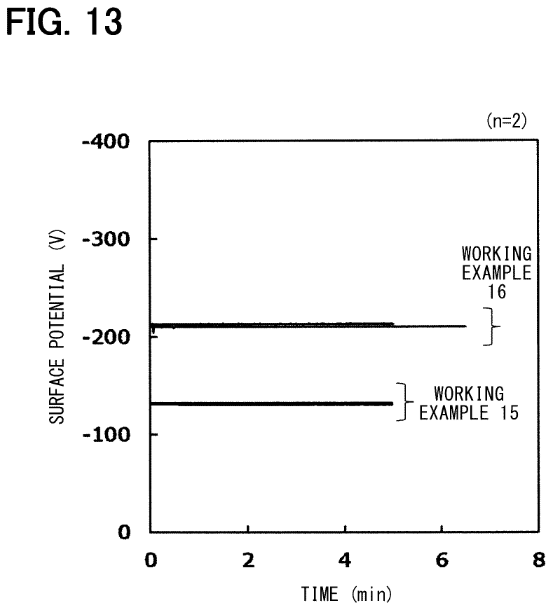

FIG. 13 shows the change in the surface potential when each sample of the electret 1 of the working examples 15 and 16 was left at room temperature after the heating treatment. At this time, the changes in the surface potential of the samples were measured over a specified period (e.g., 5 to 10 minutes), with the surface potential just after the heating treatment as the surface potential at the start of the test (elapsed time: 0). In FIG. 13, almost no change in the surface potential was observed over time in both the working example 15 and the working example 16.

(Working Examples 17 and 18) Next, electrets 1 of the working examples 17 and 18 were prepared by changing the configuration of the inner layer 4 from the electret layer 2 of the working example 1 to examine their thermal and temporal stability. The electret layer 2 has the configuration of the first embodiment shown in FIG. 2 (the lower diagram), and the inner layer 4 is configured as a multi-layered structure having a first layer 4a and a second layer 4b.

Specifically, a thermal oxide film (SiO₂) having a thickness of 1.2 μm was formed as the first layer 4a of the inner layer 4 on the upper surface 11 of the substrate 10 (conductive Si) by thermal oxidation. Next, a CVD thin layer made of SiN and having a thickness of 0.3 μm was formed as the second layer 4b by plasma CVD. On the upper surface of the CVD layer, an amorphous layer (LAO with 1% Ca added) serving as the outer layer 3 was further formed by sputtering to have a thickness of 1.3 μm, thereby forming the inorganic dielectric layer 20. Thereafter, a charging treatment was performed to obtain the electret 1 of the working example 17. Moreover, an electret 1 of the working example 18 was prepared in the same manner except that a CVD thin layer made of SiN with a thickness of 0.5 μm was used as the second layer 4b of the inner layer 4.

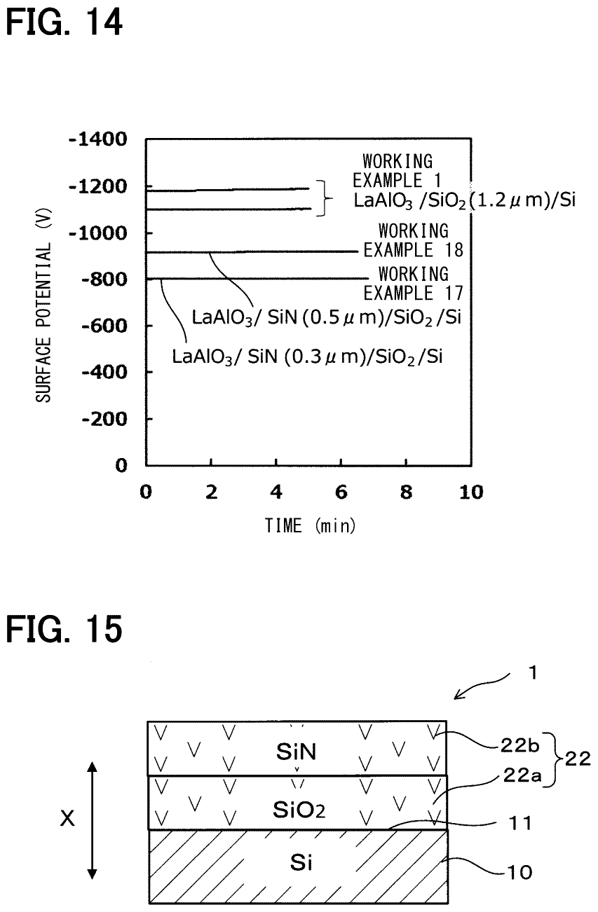

The surface potential of each of the electrets 1 of the working examples 17 and 18 was measured in the same manner as in the working example 1. Specifically, the samples were heated at 200° C. for 30 minutes after the charging treatment, and stored in the air. The surface potential was measured periodically, and the changes over a period of more than 6 minutes were examined. The results are shown in FIG. 14. FIG. 14 also shows the results for the electret 1 of the working example 1 shown in FIG. 6.

In FIG. 14, the electret 1 of the working example 17 had a surface potential of about 800 V (absolute value), and the electret 1 of the working example 18 had a surface potential of about 900 V (absolute value). In addition, for both the electrets 1 of the working examples 17 and 18, no decrease in the surface potential was observed over time. Even after more than 6 minutes had passed, the surface potential remained almost constant, showing the same tendency as the electret 1 of the working example 1.

As described above, the thermal and temporal stability of the electret 1 is improved as long as the electret layer 2 includes the outer layer 3 made of the first inorganic dielectric material and the inner layer 4 even when the inner layer 4 has a multi-layered structure formed of multiple second inorganic dielectric materials. In addition, the surface potential of the electret 1 is determined depending on the combination of the first and second inorganic dielectric materials that form the inner layer 4 and the outer layer 3 and the thickness of the inner layer 4. If the structure of the electret layer 2 is the same, the thicker the inner layer 4, the higher the surface potential.

(Comparative Examples 2 and 3) For comparison, as shown in FIG. 15, an electret 1 was prepared in which the inorganic dielectric layer 22 serving as the electret layer 2 was a multi-layer film made only of the second inorganic dielectric material. That is, there is no outer layer 3 made of the first inorganic dielectric material, and the inorganic dielectric layer 22 has a first layer 22a in contact with the substrate 10 and a second layer 22b on the first layer 22a. Specifically, a thermal oxide layer (SiO₂) having a thickness of 1.2 μm was formed on the upper surface 11 of the substrate 10 (conductive Si) to form the first layer 22a. Then, a CVD thin layer made of SiN having a thickness of 0.3 μm was formed on the upper surface of the first layer 22a by a plasma CVD method to form the second layer 22b, thereby forming the inorganic dielectric layer 22. Thereafter, a charging treatment was performed to obtain the electret 1 of the comparative example 2. Moreover, the electret 1 of the comparative example 3 was prepared by forming the inorganic dielectric layer 22 in the same manner as the comparative example 2 except that the thickness of the second layer 22b was 0.5 μm, and performing the charging treatment.

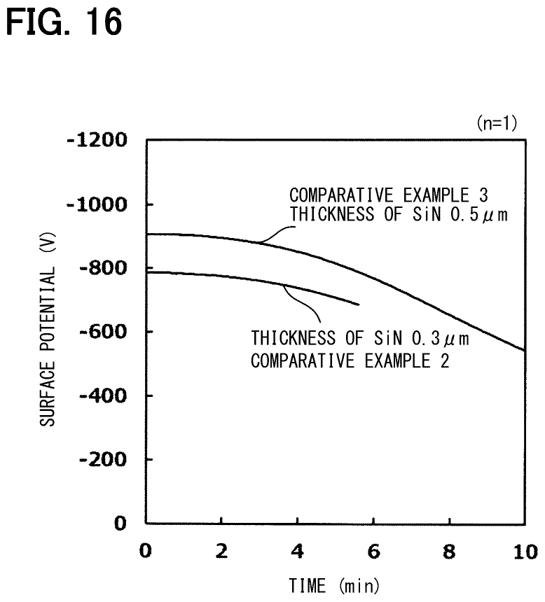

For the electrets 1 of the comparative examples 2 and 3, the surface potential was measured after charging and heating at 200° C. for 30 minutes in the same manner as in the working example 1. Furthermore, the change in the surface potential when left at room temperature (for example, for more than 5 minutes to about 10 minutes) was examined. The results are shown in FIG. 16. In FIG. 16, the electrets 1 of the comparative examples 2 and 3 exhibit a high surface potential of about 800 V (the comparative example 2) to 900 V (the comparative example 3) in absolute value until about 1 to 2 minutes have elapsed since the charging treatment. However, a gradual decrease was observed during that period, and the surface potential continues to decrease gradually thereafter. The surface potential of the comparative example 2 drops to about 700 V (absolute value) after about 6 minutes has elapsed, while the surface potential of the comparative example 3 drops to about 600 V (absolute value) after about 10 minutes has elapsed.

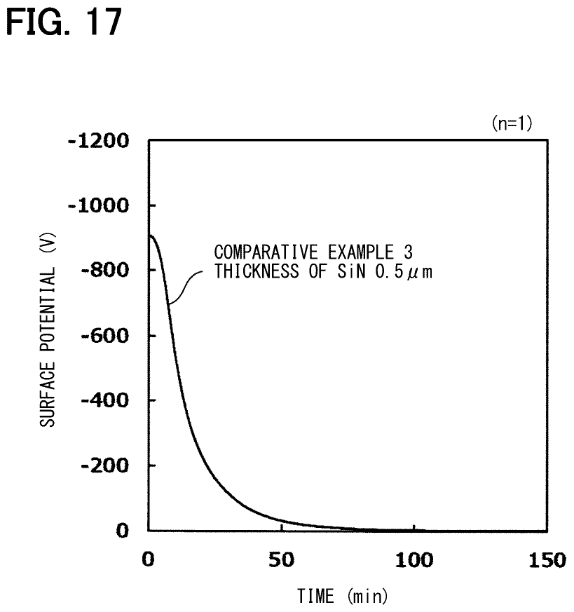

Furthermore, as shown in FIG. 17, when the measurement of the surface potential was continued for the electret 1 of the comparative example 3, the surface potential decreased to about 200 V (absolute value) after about 20 minutes had elapsed. It was also found that thereafter, although the rate of decrease became slower, the surface potential continued to decrease until it reached nearly zero in about 80 minutes.

Thus, even if the electret 1 has a structure in which multiple different inorganic dielectric materials are layered, it is impossible to suppress the decrease in the surface potential in the electret 1 that does not have an outer layer 3 made of the first inorganic dielectric material, and it is difficult to ensure the stability of the surface potential over time.

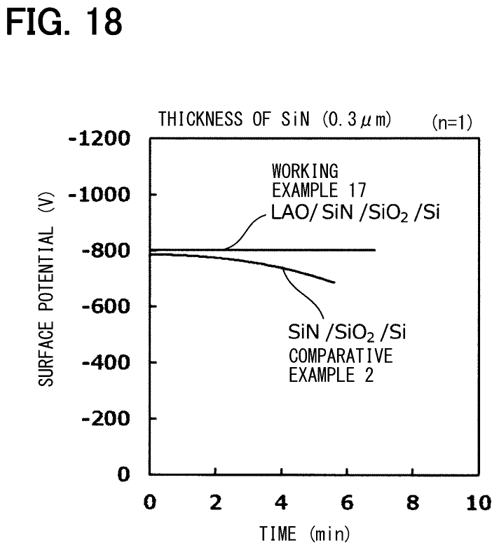

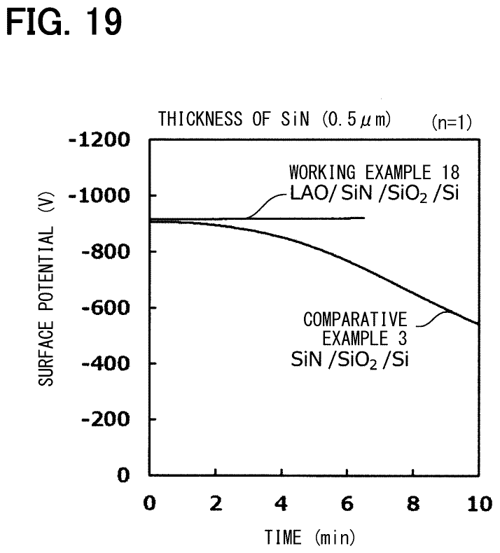

FIGS. 18 and 19 show the results for the electrets 1 of the working examples 17 and 18 together with the results for the electrets 1 of the comparative examples 2 and 3, respectively. FIG. 18 compares the results of the working example 17 and the comparative example 2 in FIG. 15. The electret 1 of the working example 17 has a surface potential that is almost constant at about 800 V (absolute value), whereas the electret 1 of the comparative example 2 has a surface potential that decreases over time, and the difference with the surface potential of the working example 17 becomes large. The same is true in the comparison results of FIG. 19. The electret 1 of the working example 18 has a surface potential that is almost constant at about 900 V (absolute value), whereas the electret 1 of the comparative example 3 has a surface potential that decreases over time, and the difference with the surface potential of the working example 18 becoms large.

As described above, the electret 1 has the electret layer 2 on the substrate 10 that includes the outer layer 3 made of the first inorganic dielectric material and the inner layer 4 made of the second inorganic dielectric material. This causes improved thermal stability and a high surface potential in a high-temperature environment of 200° C. or higher. Furthermore, the long-term stability can be obtained, making it possible to maintain a stable surface potential for a long period. The electret 1 of the present disclosure can be applied to processes, such as the manufacturing process of a power generation device, including high-temperature processes like solder reflow. The present disclosure increases the flexibility of process design, thereby contributing to reducing manufacturing costs. In addition to preventing performance degradation during the manufacturing process, stable performance can be maintained even under harsh temperature conditions during subsequent use.

In the above embodiments, the outer layer 3 of the electret layer 2 is mainly described as an amorphous layer. However, when the outer layer 3 of the electret layer 2 is an oxide crystal layer containing a composite oxide having a crystalline structure, the outer layer 3 may be a polycrystalline layer or a mixed layer containing composite oxide particles in a heat-resistant base. Moreover, the outer layer 3 of the electret layer 2 may have a multi-layered structure formed of two or more layers.

The present disclosure is not limited to the embodiments described above, and various modifications may be adopted within the scope of the present disclosure without departing from the spirit of the disclosure.

1. An electret comprising:
a substrate; and
an electret layer formed on a surface of the substrate, wherein
the electret layer is an inorganic dielectric layer that has been electrically charged, the inorganic dielectric layer including an outer layer and an inner layer that are stacked in a thickness direction of the substrate,
the outer layer contains a first inorganic dielectric material as a main component, the first inorganic dielectric material being a composite metal compound including different metal elements and having a bandgap energy of 3 eV or more, at least one of the different metal elements being a trivalent metal element, and
the inner layer contains a second inorganic dielectric material as a main component, the second inorganic dielectric material being different from the first inorganic dielectric material.

2. The electret according to claim 1, wherein
the first inorganic dielectric material has a basic composition of a composite oxide including a metal element A and a metal element B as the different metal elements,
the metal element A is a divalent or trivalent metal element, and
the metal element B is a trivalent metal element.

3. The electret according to claim 2, wherein
the composite oxide is:
a first composite oxide having a basic composition represented by a composition formula of ABO₃;
a second composite oxide having a basic composition represented by a composition formula of A₃B₅O₁₂; or
a third composite oxide having a basic composition represented by a composition formula of AB₂O₄.

4. The electret according to claim 3, wherein
the metal element A of the first composite oxide and the second composite oxide is at least one element selected from a group consisting of rare earth elements, and
the metal element A of the third composite oxide is at least one element selected from a group consisting of alkaline earth metal elements and transition metal elements.

5. The electret according to claim 4, wherein
the metal element B of the first composite oxide, the second composite oxide, and the third composite oxide is aluminum.

6. The electret according to claim 1, wherein
a relative permittivity of the first inorganic dielectric material is greater than a relative permittivity of the second inorganic dielectric material.

7. The electret according to claim 6, wherein
the second inorganic dielectric material is one of a silicon compound and an aluminum compound, or a mixture of two or more compounds selected from a group consisting of silicon compounds and aluminum compounds.

8. The electret according to claim 1, wherein
a surface potential of the electret layer has a positive correlation with a thickness of the inner layer.

9. The electret according to claim 8, wherein
the thickness of the inner layer is 0.1 μm or more.

10. The electret according to claim 1, wherein
the inner layer has a single layer structure or a layered structure, and
the outer layer is a layer of the composite metal compound having an amorphas structure or a layer of the composite metal compound having a crystal structure.
